(19) United States
(12) Patent Application Publication
(10) Pub. No.: US 2024/0383536 A1
(43) Pub. Date: Nov. 21, 2024

(54) SCALLOPED VEHICLE STRUCTURAL MEMBER

(71) Applicant: Shape Corp., Grand Haven, MI (US)

(72) Inventors: Jing Zhou, Norton Shores, MI (US); Brian Oxley, Ada, MI (US)

(73) Assignee: Shape Corp., Grand Haven, MI (US)

(21) Appl. No.: 18/666,475

(22) Filed: May 16, 2024

Related U.S. Application Data
(60) Provisional application No. 63/502,554, filed on May 16, 2023.

(51) Int. Cl. B62D 25/06; B62D 25/04

(52) U.S. Cl. CPC B62D 25/06; B62D 25/04

(57) ABSTRACT

A swept beam for a vehicle body structure includes a structural portion and a flange. The structural portion has at least a first wall and a second wall angled relative to each other along a longitudinal length of the structural portion. The structural portion also has a curved shape at least partially along the longitudinal length. A flange extends integrally from the structural portion along a compression side of the curved shape. The flange has a wave edge opposite the structural portion and exhibits a minimum of buckling.

### CROSS-REFERENCE TO RELATED APPLICATION

This application claims the benefit and priority under 35 U.S.C. § 119 (e) of U.S. provisional application Ser. No. 63/502,554, filed on May 16, 2023, the content of which is incorporated herein by reference in its entirety.

### TECHNICAL FIELD

The present disclosure relates generally to structural members for vehicles and more specifically to scalloped structural members for curved vehicle body structures.

### BACKGROUND

Automobiles and other vehicles typically include structural framework components that define a cabin space for enclosing and protecting a vehicle's occupants. In a collision the framework components may be subjected to large impact forces. The ability of the framework component to resist deformation while being subjected to large magnitude forces is critical to ensuring passenger safety. Increasing deformation resistance can be accomplished by increasing material usage, such as wall thickness, which increases component weight. Additional material usage also increases manufacturing burdens. It would be beneficial to provide a high-strength framework component with efficient manufacturability and material usage.

### SUMMARY

This disclosure provides a swept beam for a vehicle body structure that functions to support the vehicle body components, and to receive and absorb impact loads from vehicle collisions. The swept beam includes a structural portion, such as a tube profile, and a flange extending integrally from the structural portion, where the beam is at least curved at least partially along its length to define a swept shape. The flange has a wave edge opposite the structural portion where the wave edge functions to provide the flange with a minimum of buckling deformation. The swept beam may include an ultra-high strength steel sheet material and may be roll-formed to provide the structural portion, such as the tube profile. The wave edge of the flange may include a series of repeating curves, such as a sinusoidal wave shape.

In some examples, the swept beam may include a tube profile having a longitudinal length, and where the tube profile is curved along its longitudinal length and where the flange has a minimum of buckling deformation, such as a minimum of buckling deformation less than 2° or a minimum of buckling defamation less than 0.5 mm. In some examples, the flange has no buckling deformation. The flange may have a flange length, where the wave edge may have a pitch between 1 and 4 times the flange length. The wave edge may have a depth between 50% and 80% of the flange length.

One aspect of the present disclosure provides a vehicle body structure comprising an A pillar, a roof rail, and a swept beam extending between the A-pillar and the roof rail. The swept beam includes a tube profile and a flange extending from the tube profile. The flange may extend at least partially along a compression side of the curved shape of the tube profile. The flange has a wave edge opposite the tube profile. The swept beam may include an ultra-high strength steel sheet material. The tube profile may be roll-formed. The wave edge may include a series of repeating curves. The wave edge may include a sinusoidal wave shape. The swept beam may include a tube profile having a longitudinal length, and where the tube profile is curved along its longitudinal length and where the flange has a minimum of buckling deformation. The flange may have no buckling deformation. The minimum of buckling deformation may be less than 2°. The minimum of buckling defamation may be less than 0.5 mm. The flange may have a flange length, where the wave edge may have a pitch between 1 and 4 times the flange length. The wave edge may have a depth between 50% and 80% of the flange length.

Each of the above independent aspects of the present disclosure, and those aspects described in the detailed description below, may include any of the features, options, and possibilities set out in the present disclosure and figures, including those under the other independent aspects, and may also include any combination of any of the features, options, and possibilities set out in the present disclosure and figures.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a schematic perspective view of a vehicle having a framework architecture.

FIG. 2 is a schematic perspective view of a swept beam at the transition of the A-pillar to the roof rail as shown in FIG. 1.

FIG. 3 is a cross-sectional view of the swept beam of FIG. 2 taken at line III-III.

FIG. 4 is section side view of the swept beam of FIGS. 1-3.

Like reference numerals indicate like parts throughout the drawings.

### DETAILED DESCRIPTION

Swept beams for vehicles are disclosed herein in various implementations as structural components and impact energy absorption and management devices that are used in conjunction with other vehicle components to absorb and manage impact loads and energy so as to minimize damage and intrusion during an impact to the vehicle. For example, a swept beam may be employed as a part of, or at a transition between, the A-pillar, a roof rail, and/or a hinge pillar on each side of the passenger cabin of a vehicle. The swept beam may also be employed in other areas of a vehicle body structure, such as a part of, or between a B-pillar and a roof rail, between hinge pillars, beams, bulkheads, rails, sills, rockers, cross-members, and any other suitable locations or combinations thereof.

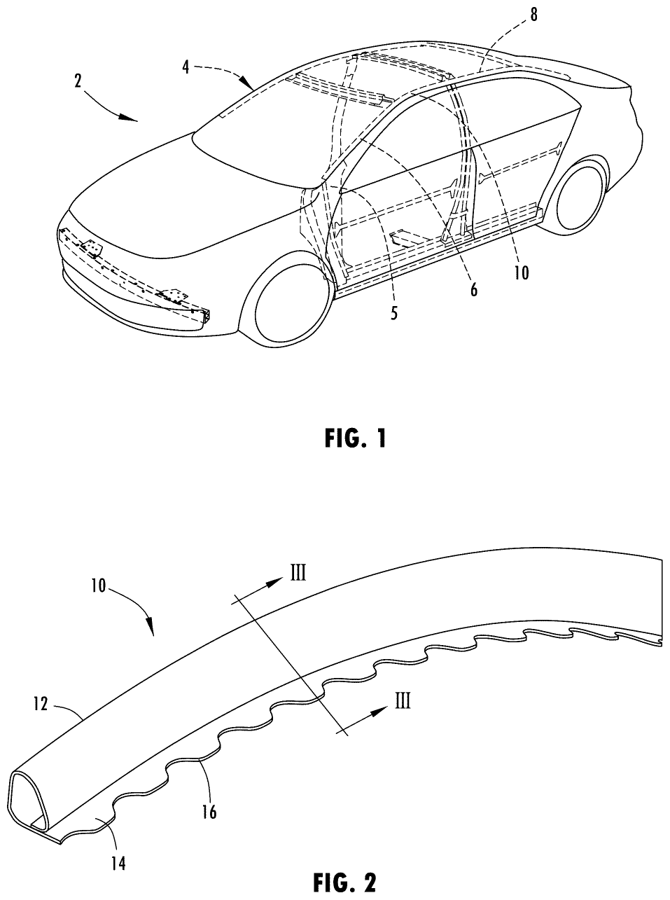

Referring to FIG. 1, a vehicle 2 is illustrated having a frame structure 4 partially shown. The frame structure 4 includes an A-pillar extending between a body frame member 5 and the roof rail 8. The vertical or upwardly extending A-pillar 6, the horizontal roof rail 8, or portions thereof may be formed as a swept beam 10. The swept beam 10 of the present disclosure includes a tube profile 12 and a flange 14 integrally extending from the tube profile 12. The tube profile 12 may comprise single-hollow elongated tube structure roll-formed from a sheet material, such as an ultra-high strength steel. An ultra-high strength steel is one with an ultimate tensile strength of greater than 780 MPa, or in some examples greater than 1,000 MPa. The swept beam 10 may be roll formed into a linear tube and then processed, for example through a sweeping process, to impart a curve, bend, or arc along its length. The particular nature or shape of the curve may be dictated by the intended application of the swept beam 10, such as to form a transition between the A-pillar 6 and the roof rail 8 of a vehicle body structure 4. The curve imparted to the swept beam 10 may be a complex curve in one or more dimensions and with multiple radii of curvature along the longitudinal length of the swept beam 10.

The flange 14 extending from the tube profile 12 of the swept beam 10 may provide an attachment surface, such as for attachment by weld, adhesive, threaded fastener or the like, to a body panel, a frame member 5, or the A-pillar 6, the roof rail 8, a windshield header (not shown), other components, or combinations thereof. Depending on the nature of the curvature imparted to a swept beam, a planar flange may undergo compressive buckling, leading to dimensional instability, residual stresses, and problems attaching to mating components. To overcome the potential of buckling during the bending process, the flange 14 of the swept beam 10 is shaped to have a wave edge 16 opposite the tube profile 12, as illustrated in FIG. 2. The wave edge 16 creates a material discontinuity that prevents the flange from buckling during the bending process. The flange 14 may be cut or trimmed to include the wave edge 16 prior to a forming process, such as a roll-forming process, where the tube profile 12 is formed. The flange 14 may be cut or trimmed to include the wave edge 16 after the forming process of the tube profile 12, but prior to the sweeping process where the beam 10 is bent or curved. The wave edge 16 allows the flange 14 to conform to the curvature of the tube profile 12 with a minimum of buckling deformation. For example, the minimum of buckling may have an amplitude of less than 0.5 millimeters deviation δ from the planar extension of the tube profile at the proximate point where the flange 14 extends integrally from the tube profile 12.

The wave edge 16 may comprise a series of repeating curves along the edge. The wave edge 16 may be in the shape of a sinusoidal wave. The wave edge 16 may be constant or may vary in shape along the length of the swept beam 10 depending on the radius of curvature proximate to the particular point along the swept beam 10. For example, where the radius of curvature is smaller, as in a tighter curve, the wave edge 16 may have a higher frequency, that is more instances of narrower wave forms. Conversely, where the radius of curvature is larger, as in a looser curve, the wave edge 16 may have a lower frequency, with fewer instances of wider wave forms. The depth D, or amplitude, of the wave forms may also vary along the length of the swept beam 10 and may be depend on the local radius of curvature of the swept beam 10. The wave edge 16 may extend all or a portion of the length of the swept beam 10. The flange 14 may include a straight edge in a portion of the swept beam 10 that is not bent or curved. The flange 14 may be absent in a portion of the swept beam 10 that is not bent or curved.

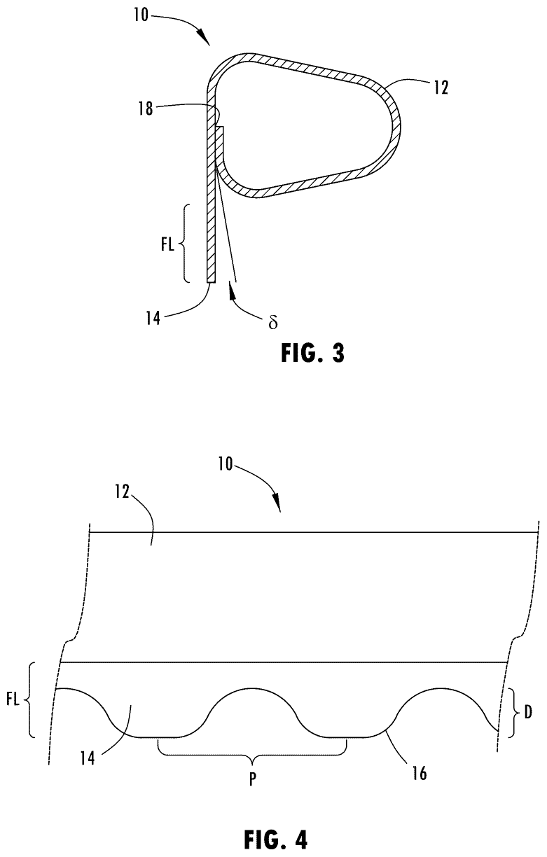

Referring to FIGS. 2-4, a swept beam 10 is illustrated. The swept beam 10 is bent in a complex curve so that, once installed, it curves in the vertical dimension to transition from the A-pillar to the roof rail, and in the horizontal dimension to accommodate the placement of the A-pillar further away from the center line of the vehicle than the roof rail. Thus, the curved shape of the swept beam 10 includes a compression side along the concave curves in both the horizontal and vertical dimensions, and likewise the swept beam 10 includes a tension side along the convex curves in both the horizontal and vertical dimensions. The swept beam 10 is formed of an ultra-high strength steel having an ultimate tensile strength greater than 780 MPa with a substantially constant sheet thickness. In this instance, and elsewhere herein, “substantially constant” refers to a common engineering dimension with a tolerance common to the intended application. For example, a sheet material may have a nominal thickness dimension of 1.21 millimeters with a tolerance of +0.11/−0.10 millimeters to have a substantially constant thickness. The sheet may have a nominal thickness of 1.2 millimeters with a tolerance of +0.06 millimeters. The sheet may have a thickness between 1.2 millimeters and 2.1 millimeters, and may be selected depending on the size or shape of intended vehicle application. Furthermore, in some examples of the sheet material, an ultra-high strength steel has an ultimate tensile strength greater than 1,000 MPa, and in additional examples, the sheet material that forms the tubular beam may be an advanced-high strength steel with a tensile strength greater than 550 MPa.

The swept beam 10 includes a single-hollow tube profile 12 and a flange 14 extending integrally from the tube profile 12. The tube profile 12 may have a circular, polygonal, rounded polygonal or other suitable cross-sectional shape. The tube profile 12 is illustrated having a rounded triangular cross-sectional shape with a first end 18 disposed internal to the single-hollow tube profile 12 and a second end terminating at the distal end of the flange 14. In other alternatives, the tube profile 12 may comprise a multi-hollow tube including one or more inner walls dividing the internal space of the tube profile 12. The tube profile 12 may include a perimeter length of between 100 millimeters and 200 millimeters, exclusive of the flange 14. In additional examples, the perimeter length of the tube profile may be less than 100 millimeters, such as greater than 70 millimeters, or greater than 200 millimeters, such as less than 300 millimeters.

The flange 14 integrally extends away from the tube profile 12 for a flange length FL of between 15 millimeters and 200 millimeters, or in some examples between 20 millimeters and 60 millimeters, or in some examples between 30 millimeters and 80 millimeters. In personal passenger vehicles, the flange length may be less than 35 millimeters. The flange length FL may be substantially constant, or may vary along the longitudinal length of the swept beam 10. The flange length FL may vary depending on the position along the length of the swept beam 10, depending on the local radius of curvature along the length of the swept beam 10, or both. The wave edge 16 of the flange 14 may be defined in a wave form having a pitch and an amplitude. The pitch P of waveforms may be between 1 and 4 times the flange length FL. The depth D of the waveforms may extend between 50% and 80% of the flange length FL. The wave edge 16 allows the flange 14 to integrally extend linearly from the tube profile 12 without buckling or with only minimal buckling. The magnitude of buckling can be evaluated as a measure of the deviation δ from linearity with the tube profile at any point along the length of the swept beam 10. The deviation δ can be represented either as an angular or a linear displacement amount at the distal end. The minimal buckling means a deviation δ of less than 2° from linear or less than 0.5 millimeters of edge displacement.

For purposes of this disclosure, the term “coupled” (in all of its forms, couple, coupling, coupled, etc.) generally means the joining of two components directly or indirectly to one another. Such joining may be stationary in nature or movable in nature; may be achieved with the two components and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A swept beam configured for a vehicle body structure, the swept beam comprising:
a tube profile having a curved shape along its longitudinal length; and
a flange extending integrally from the tube profile along a compression side of the curved shape; the flange having a wave edge opposite the tube profile.

2. The swept beam of claim 1, comprising a metal sheet forming the tube profile and the flange.

3. The swept beam of claim 2, wherein the metal sheet comprises an ultra-high strength steel sheet roll-formed to form the tube profile.

4. The swept beam of claim 2, wherein the wave edge is defined by a series of repeating curves formed along an edge of the metal sheet.

5. The swept beam of claim 1, wherein the wave edge comprises a sinusoidal wave shape.

6. The swept beam of claim 1, wherein the flange has a minimum of buckling deformation of less than 2°.

7. The swept beam of claim 1, wherein the flange has a minimum of buckling deformation of less than 0.5 mm.

8. The swept beam of claim 1, wherein the flange comprises a flange length, the wave edge comprising a pitch between 1 and 4 times the flange length.

9. The swept beam of claim 1, wherein the flange comprises a flange length, the wave edge comprising a depth between 50% and 80% of the flange length.

10. A swept beam configured for a vehicle body structure, the swept beam comprising:
a structural portion having at least a first wall and a second wall angled relative to each other along a longitudinal length of the structural portion, the structural portion having a curved shape at least partially along the longitudinal length; and
a flange extending integrally from the structural portion along a compression side of the curved shape; the flange having a wave edge opposite the structural portion.

11. The swept beam of claim 10, comprising an ultra-high strength steel sheet material.

12. The swept beam of claim 10, wherein the structural portion comprises a tube profile along the longitudinal length having a hollow area.

13. The swept beam of claim 10, wherein the wave edge is defined by a series of repeating curves.

14. The swept beam of claim 13, wherein the flange has a minimum of buckling deformation of less than 2°.

15. The swept beam of claim 13, wherein the flange has a minimum of buckling deformation of less than 0.5 mm.

16. The swept beam of claim 15, wherein the flange comprises a flange length, the wave edge comprising a pitch between 1 and 4 times the flange length.

17. The swept beam of claim 16, wherein the wave edge comprising a depth between 50% and 80% of the flange length.

18. A vehicle body structure comprising:
an A-pillar;
a roof rail; and
a swept beam extending between the A-pillar and the roof rail, the swept beam comprising
a tube profile; and
a flange extending integrally from the tube profile; the flange having a wave edge opposite the tube profile and exhibiting a minimum of buckling.

19. The vehicle body structure of claim 18, wherein the flange has a minimum of buckling deformation of less than 2°.

20. The vehicle body structure of claim 18, wherein the swept beam comprises a metal sheet forming the tube profile and the flange, and wherein the metal sheet comprises an ultra-high strength steel sheet roll-formed to form the tube profile.
